(19) United States
(12) Patent Application Publication
(10) Pub. No.: US 2013/0102333 A1
(43) Pub. Date: Apr. 25, 2013

(54) SYSTEMS AND METHODS FOR DISPATCHING UTILITY REPAIRS

(71) Applicant: Quang Binh Dam, Atlanta, GA (US)

(72) Inventor: Quang Binh Dam, Atlanta, GA (US)

(73) Assignee: General Electric Company, Schenectady, NY (US)

(21) Appl. No.: 13/277,129

(22) Filed: Oct. 19, 2011

(51) Int. Cl. H04W 4/02

(52) U.S. Cl. 455/457

(57) ABSTRACT

A method to dispatch utility repairs. The method may include displaying directions to a location of a first work assignment on an electronic device. The directions may update as the electronic device changes location. The method may also include displaying items to complete at least a portion of the first work assignment. The items may be displayed when the electronic device location is substantially the same as the first work assignment location. The method may include detecting at least one operator acknowledgment of completion after the portion of the first work assignment is complete or after all portions of the first work assignment are complete. The method may also include displaying directions to a location of a second work assignment when the electronic device detects that all portions of the first work assignment are complete.

### BACKGROUND OF THE INVENTION

The subject matter disclosed herein relates generally to utility systems and, more particularly, to systems and methods for dispatching utility repairs.

A utility system provides power to customers connected to a power grid. During operation of the utility system, certain components of the system may wear out or otherwise have degraded performance. A field crew may be sent to locations in the utility system to replace or upgrade the performance of system components. To coordinate multiple field crews, a dispatching system may be used. In certain dispatching systems not related to utility systems, such as systems for package delivery, the dispatching system may include an electronic device used by a package delivery person to instruct the person where to deliver packages. Such a device may also allow a person receiving a package to sign the device to show receipt of the package. In other dispatching systems, an installation person may use an electronic device to aid them in the installation. And still in other dispatching systems, a vehicle driver may use an electronic device that provides a visual driving route to the driver. Unfortunately, many dispatching systems are not able to dynamically handle changing work assignments and work assignment timing. Further, electronic devices used by field crews may not allow the field crew to efficiently utilize their time and may utilize multiple applications to complete work assignments.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a method to dispatch a repair for a utility system includes displaying directions to a location of a first work assignment on an electronic device. The directions update as the electronic device changes location. The method also includes displaying items to complete at least a portion of the first work assignment on the electronic device. The items are displayed when the electronic device location is substantially the same as the first work assignment location. The method includes detecting, on the electronic device, at least one operator acknowledgment of completion after the portion of the first work assignment is complete or after all portions of the first work assignment are complete, or some combination thereof The method also includes displaying directions to a location of a second work assignment on the electronic device when the electronic device detects that all portions of the first work assignment are complete.

In a second embodiment, a system to dispatch a repair for a utility system includes a dispatching server configured to receive work assignments to complete work orders within the utility system and assign the work assignments to field crews. The dispatching server is also configured to provide the work assignments to the field crews and receive statuses of the work assignments from the field crews at any of a plurality of stages of completion. The dispatching server is configured to receive acknowledgments from the field crews when the work assignments are complete and reassign work assignments at any time of day based at least in part on the statuses and on the acknowledgments from the field crews. The dispatching server is also configured to provide reassigned work assignments to the field crews.

In a third embodiment, an article of manufacture for a dispatching system includes one or more tangible, machine-readable media having encoded thereon processor-executable instructions. The media includes instructions to display directions to a location of a first work assignment on an electronic device and instructions to update the directions as the electronic device changes location. The media also includes instructions to display items to complete at least a portion of the first work assignment on the electronic device. The items are displayed when the electronic device location is substantially the same as the first work assignment location. The media includes instructions to detect, on the electronic device, at least one operator acknowledgment of completion after the portion of the first work assignment is complete or after all portions of the first work assignment are complete, or some combination thereof The media also includes instructions to send the at least one operator acknowledgment of completion to a dispatching server. The at least one operator acknowledgment of completion indicates a status of the first work assignment. The media includes instructions to display directions to a location of a second work assignment on the electronic device when the electronic device detects that all portions of the first work assignment are complete.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a utility system which includes a dispatching system to dispatch utility repairs in accordance with an embodiment;

FIG. 2 is a block diagram of a dispatching system that includes a dispatching server and handheld electronic devices for field crews; and

FIG. 3 is a flowchart describing the dispatching system including a dispatching server coordinating utility repairs with a handheld electronic device of a field crew.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As may be appreciated, a utility system is a dynamic system that may change quickly over a period of time. When utility system changes involve utilizing field crews, a dispatching system that dynamically updates work assignments may enable the utility system to operate smoothly and efficiently. Such a system that simplifies and streamlines dispatching and reporting that occurs between a dispatching server and field crews is presented herein.

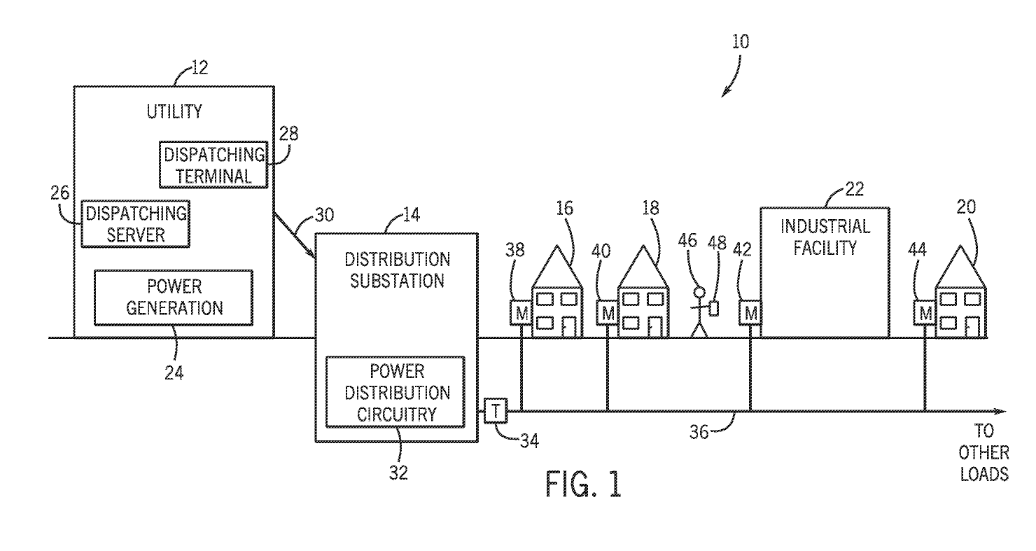

With the foregoing in mind, FIG. 1 is a block diagram of an embodiment of a utility system 10. In the illustrated embodiment, the utility system 10 includes a utility 12 and a distribution substation 14. The utility 12 provides electrical power to loads connected to the utility system 10, such as residences 16, 18, and 20, and an industrial facility 22. The utility 12 includes power generation 24, which may include one or more generators for converting mechanical energy into electrical power. The utility 12 also includes a dispatching server 26 for dispatching utility repairs to maintain the utility system 10. A dispatching terminal 28 may communicate with the dispatching server 26 to provide updates to the server 26 and to receive dispatching information from the server 26. For example, an update may be a new or changed work assignment, a change to the dispatching schedule, etc.

Electrical power is carried from the utility 12 to the distribution substation 14 using cable system 30. The distribution substation 14 includes power distribution circuitry 32 which may transform voltage from high to low with a step-down transformer, or transform voltage from low to high with a step-up transformer. Furthermore, the power distribution circuitry 32 may include switches, protection equipment, and control equipment, in addition to one or more transformers, for distributing electrical power through the utility system 10.

As illustrated, electrical power may flow from the distribution substation 14 through one or more transformers 34 separate from the distribution substation 14. Further, electrical power flows through a cable system 36 to the residences 16, 18, and 20, and the industrial facility 22 (e.g., an underground or overhead cable system 36). As may be appreciated, the cable system 36 may include additional power distribution circuitry. Before flowing to the residences 16, 18, and 20, and the industrial facility 22, electrical power flows through utility meters 38, 40, 42, and 44. The meters 38, 40, 42, and 44 are used to measure the amount of electrical power used by the residences 16, 18, and 20, and the industrial facility 22. It should be noted that in other embodiments of utility systems 10, the power distribution circuitry 32, the transformers 34, the cable systems 36, and the meters 38, 40, 42, and 44 may be arranged in a different manner than illustrated in FIG. 1.

As may be appreciated, various components of the utility system 10 may need maintenance. Therefore, maintenance information is provided to the dispatching server 26 which coordinates work distribution to an operator in a field crew 46. For example, the dispatching server 26 may provide work assignments to a handheld electronic device 48 used by the field crew 46. The field crew 46 may then use the handheld electronic device 48 to perform the work assignments as will be described in greater detail below. The handheld electronic device 48 may be any suitable networked device, such as a smartphone or tablet, for example.

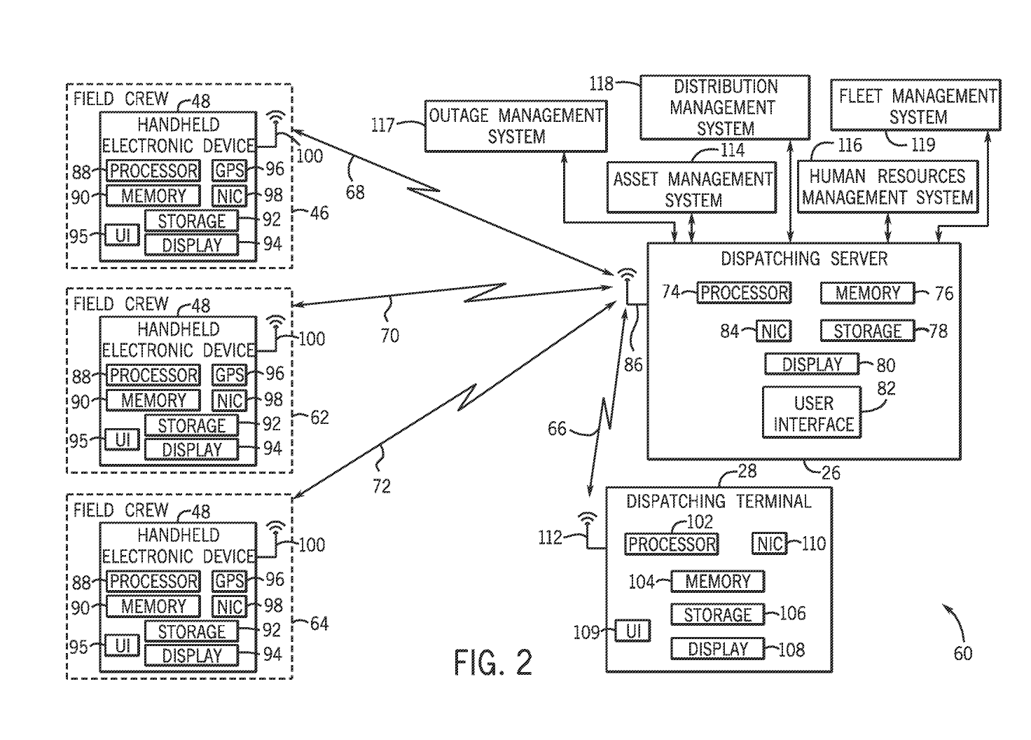

A dispatching system 60 of FIG. 2 may coordinate work assignments assigned to the field crew 46. As illustrated in FIG. 2, the dispatching system 60 includes the dispatching server 26 and handheld electronic devices 48 for each field crew 46, 62, and 64. Although only three field crews 46, 62, and 64 are shown, the dispatching system 60 may accommodate more or fewer field crews, as desired. The dispatching terminal 28 communicates with the dispatching server 26 using a communication channel 66. The communication channel may be any suitable form of wireless communication. Further, the field crews 46, 62, and 64 use the handheld electronic devices 48 to communicate with the dispatching server 26, using communication channels 68, 70, and 72, respectively. As may be appreciated, the server 26 and terminal 28 may include multiple computing devices.

As illustrated, the dispatching server 26 includes a processor 74, memory 76, storage 78, a display 80, a user interface 82, and a network interface card 84. Each of these devices may include hardware elements (including circuitry), software elements (including computer code stored on a computer-readable medium) or a combination of both hardware and software elements. In certain embodiments, the dispatching server 26 includes a wireless antenna 86 for wireless communications. It should be noted that the dispatching server 26 is merely one example of a particular implementation and is intended to illustrate the types of components that may be present in the dispatching server 26.

It should be noted that the processor 74 and/or other data processing circuitry may be generally referred to herein as “data processing circuitry.” This data processing circuitry may be embodied wholly or in part as software, firmware, hardware, or any combination thereof. Furthermore, the data processing circuitry may be a single contained processing module or may be incorporated wholly or partially within any of the other elements within the dispatching server 26.

The processor 74 and/or other data processing circuitry may be operably coupled with the memory 76 and the nonvolatile storage 78 to execute instructions. Such programs or instructions executed by the processor 74 may be stored in any suitable article of manufacture that includes one or more tangible, computer-readable media at least collectively storing the instructions or routines, such as the memory 76 and the nonvolatile storage 78. The memory 76 and the nonvolatile storage 78 may include any suitable articles of manufacture for storing data and executable instructions, such as random-access memory, read-only memory, rewritable flash memory, hard drives, and optical discs.

The display 80 may be any type of display for showing dispatching information, such as any device that may depict the status of current work assignments, and scheduled work assignments. The user interface 82 of the dispatching server 26 may enable a user to interact with the dispatching server 26 (e.g., input a new work assignment into the server 26). The network interface 84 enables the dispatching server 26 to communicate with the handheld electronic devices 48 of the field crews 46, 62, and 64. The network interface 84 may include, for example, interfaces for a local area network (LAN), such as an 802.11x Wi-Fi network, and/or for a wide area network (WAN), such as a 3G or 4G cellular network. To communicate wirelessly, the dispatching server 26 may use the antenna 86.

The handheld electronic devices 48 each include a processor 88, memory 90, storage 92, a display 94, a user interface (UI) 95, satellite-based positioning system (e.g., GPS) location circuitry or device 96, a network interface card 98, and an antenna 100. In addition, the dispatching terminal 28 includes a processor 102, memory 104, storage 106, a display 108, a user interface (UI) 109, a network interface card 110, and an antenna 112. As may be appreciated, the processors 88 and 102, memory 90 and 104, storage devices 92 and 106, displays 94 and 108, user interfaces 95 and 109, network interfaces 98 and 110, and antennas 100 and 112 may function in a similar manner to the respective components of the dispatching server 26 described above. Further, the positioning system location circuitry 96 may provide each of the handheld electronic devices 48 with information relating to the positions (e.g., location and/or orientation) of the devices 48. As may be appreciated, each electronic device 48 may also include other hardware and/or software to determine the location and the orientation of the device 48. For example, each device 48 may include various accelerometers for determining the location and/or orientation of the device 48.

During operation, the dispatching server 26 receives work assignments, or work orders to be completed within the utility system 10. Specifically, the dispatching server 26 may receive work assignments from the dispatching terminal 28, or from another source. For example, the dispatching server 26 may receive work assignments from an asset management system 114. The asset management system 114 may include information about the current status of devices within the utility system 10. In certain embodiments, the asset management system 114 may include maintenance schedules that document when utility components need to be examined or replaced. Further, the asset management system 114 may include indications of failed utility components. For example, the dispatching server 26 may receive information from the asset management system 114 indicating an emergency repair is needed. The dispatching server 26 may also have access to a human resources management system 116. This system 116 may include information about the number of hours a field crew is available to work, the number of individuals in a field crew, and so forth.

The dispatching server 26 may also receive information from an outage management system (OMS) 117, a distribution management system (DMS) 118, and/or a fleet management system 119. The OMS 117 and the DMS 118 may include features for outage tracking, creating or updating work assignments, and/or assigning work assignments to the field crews 46, 62, and 64. Further, the fleet management system 119 may include information about vehicle inventories (e.g., number and types of vehicles in the fleet), vehicle maintenance, vehicle availability, and vehicle equipment (e.g., the equipment available on-board each vehicle in the fleet).

The dispatching server 26 utilizes all available information (e.g., from the asset management system 114, human resources management system 116, OMS 117, DMS 118, fleet management system 119, and other systems) to determine the allocation, priority, timing, etc. of the work assignments to be assigned to the field crews 46, 62, and 64 to provide an integrated approach to allocating the assignments (e.g., integrating information from multiple sources). In certain embodiments, the dispatching server 26 uses formulas and/or algorithms to determine how to allocate the work assignments. For example, the dispatching server 26 may use a traveling salesman algorithm to determine how to allocate work assignments. As may be appreciated, the dispatching server 26 may automatically assign work assignments, or a dispatcher (e.g., human operator) may manually override and/or assign work assignments using the dispatching terminal 28 and/or the user interface 82 of the dispatching server 26. It should be noted that the dispatching terminal 28 may be used to view a dispatching schedule, modify work assignments, enter new work assignments, modify work assignments statuses, modify the dispatching schedule, and/or add information from the field crews 46, 62, and 64.

The dispatching server 26 may coordinate the allocation of work assignments to field crews 46, 62, and 64 in real time throughout a work day or shift and may provide the work assignments to the field crews 46, 62, and 64. In other words, the dispatching server 26 may continuously coordinate the allocation of work assignments to the field crews 46, 62, and 64 and the allocation of work assignments may be based at least partly on the status of work assignments being completed, the nature of work assignments (e.g., type of work involved, equipment required, etc.), the priority or urgency of new or existing work assignments, the occurrence of new work assignments, the utility resources available, the number of hours worked by the field crews 46, 62, and 64, a time of day, distances traveled by the field crews 46, 62, and 64, distances to be traveled by the field crews 46, 62, and 64, the physical location of the field crews 46, 62, and 64, the physical location of outages, the number of vehicles operating in the fleet, the maintenance records of a work vehicle, the availability of a work vehicle, and the equipment installed on a work vehicle. For example, the dispatching server 26 may receive information indicating an emergency utility grid condition and the server 26 may determine the closest field crew 46, 62, or 64 to the emergency condition and immediately assign the field crew 46, 62, and 64 to go to the emergency condition location and perform work there.

The dispatching server 26 may send and receive communication with the handheld electronic devices 48 of the field crews 46, 62, and 64 at any time. In particular, the dispatching server 26 and the devices 48 may communicate updates and receive information, such as statuses of work assignments at any stage of completion and acknowledgments when work assignments are complete. For example, the dispatching server 26 may assign or reassign work assignments and reroute the organization of a field crew's work assignments to be performed at any time of day based at least in part on the statuses and acknowledgments from the field crews 46, 62, and 64. Further, the dispatching server 26 may provide the reassigned work assignments to the field crews 46, 62, and 64. The dispatching server 26 may receive responses from the field crews that assignments or reassignments of work assignments have been accepted. In certain embodiments, the dispatching server 26 may also determine costs associated with completing a work assignment, including costs associated with reassigning a work assignment to a different field crew or postponing a work assignment.

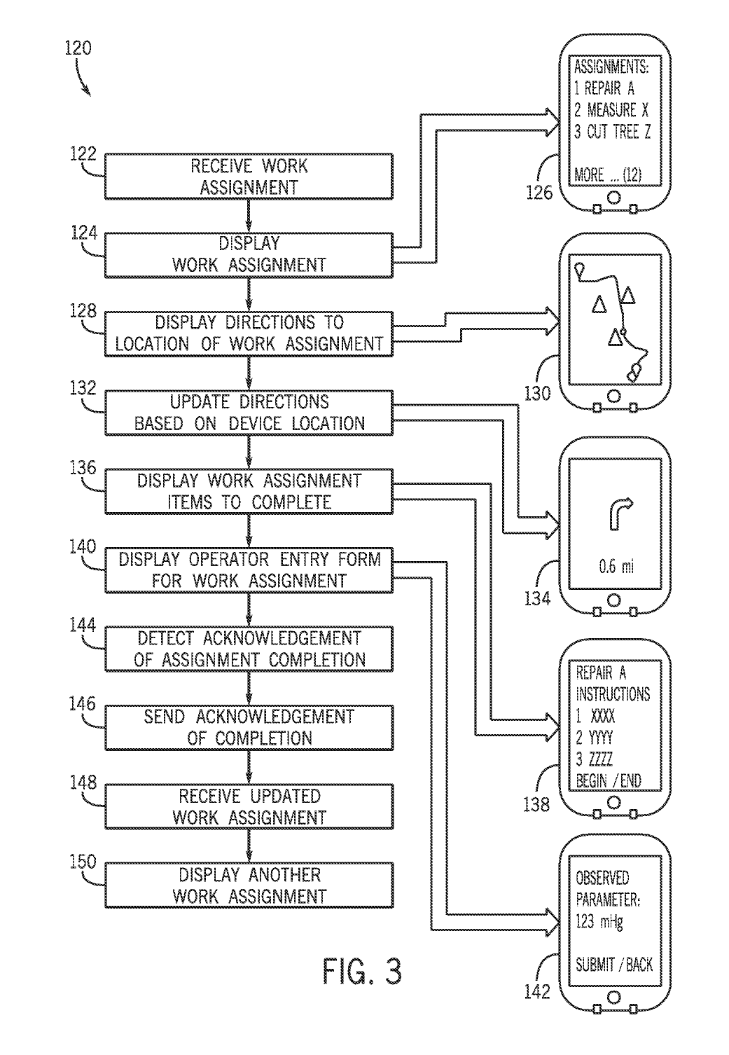

As may be appreciated, the dispatching system 60 may be used to coordinate distribution of work assignments among various field crews 46, 62, and 64. FIG. 3 is a flowchart describing a method 120 of dispatching a repair from the dispatching system 60. In particular, the dispatching server 26 is utilized for coordinating utility repairs with the handheld electronic devices 48 of the field crews 46, 62, and 64. It should be noted that the handheld electronic devices 48 may utilize a single application or interface to display information relating to work assignments being completed. For example, the devices 48 may each have a single application that is used to receive work assignments, view work assignments, display updated directions, display items to complete, display forms for data entry, and provide status updates to the dispatching server 26. Further, the application may transition automatically between displaying different types of information based on the location of the device 48 and the status inputs provided by the field crews 46, 62, and 64. For example, the application may transition from displaying directions to displaying work assignment items with no user input and based on the location of the device 48. Further, the application may transition from displaying a data entry form to displaying directions to a new work assignment, such as after the field crew 46, 62, and 64 submits the data entry form.

At block 122, an operator of a field crew 46, 62, and 64 may receive a work assignment on the handheld electronic device 48. As may be appreciated, the work assignment may be sent from the dispatching server 26 to the handheld electronic device 48. In certain embodiments, the field crews 46, 62, and 64 may receive multiple work assignments as a group, while in other embodiments, the field crews 46, 62, and 64 may receive work assignments one at a time throughout the day, such as receiving a new work assignment after each work assignment is complete. Further, the field crews 46, 62, and 64 may receive an initial group of work assignments for a shift or workday from a starting work location, such as an office. Next, at block 124, a current work assignment may be displayed on the device 48. The display 94 of the device 48 may include a summary of instructions for the work assignment 126. In certain embodiments, the work assignment may include an option for the field crew 46, 62, and 64 to accept or reject the work assignment.

Then, at block 128, the device 48 may display directions to the location of the work assignment. For example, the device 48 may show a route on a map 130 from the device 48 location to the work assignment location. In certain embodiments, the directions may be a list of turn-by-turn directions from the device 48 location to the work assignment location. As may be appreciated, the device 48 may determine the route 130 to the work assignment location based on the current location of the device 48 as determined through the positioning system location circuitry 96 and the location of the work assignment received from the dispatching server 26. In some embodiments, the device 48 may be configured to provide audible turn-by-turn directions, or other types of audible directions. At block 132, as the device 48 changes locations, the directions displayed on the device 48 may be updated as the location of the device 48 changes. For example, the device 48 may update a current travel instruction 134 displayed on the device 48 based on the physical location of the device 48 and the location of the work assignment. In certain embodiments, the device 48 may display the current location of the device 48 along the route on the map as the device 48 moves toward the work assignment location. Further, in some embodiments, the device 48 may provide updated directions audibly.

As may be appreciated, the dispatching server 26 may receive updates from the device 48 indicating the physical location of the device 48. Further, the dispatching server 26 may use these indications to update field crew 46, 62, or 64 work assignments and estimated time of completion of work assignments. In certain embodiments, a revised group of work assignments may be sent to the device 48, or a revised work assignment may be sent to the device 48 based on a revised field crew 46, 62, and 64 schedule determined by the dispatching server 26. When the physical location of the device 48 reaches the work assignment location (e.g., when the device 48 location is substantially the same as the work assignment location), the device 48 displays instructions for completing the work assignment without the field crew making any selections on the device 48 (e.g., the device automatically transitions from displaying directions to displaying work assignment instructions), at block 136. In certain embodiments, the device 48 may display step-by-step instructions 138 for completing the work assignment. Further, the device 48 may send a status update to the dispatching server 26 to notify the server 26 that the device 48 location is substantially the same as the work assignment location. This status update provides the server 26 with locations of the field crews 46, 62, and 64 and may be used by the server 26 for allocating and/or reallocating work assignments. In addition, this status update may be used by the device 48 and/or server 26 as an indication that it is time to transition the device 48 display 94 to display instructions for a work assignment. In certain embodiments, the instructions for the work assignment may be a portion of the instructions to complete the work assignment, the complete instructions for the work assignment, or some combination of the two. The work assignment instructions may include a selection for the field crew 46, 62, and 64 to indicate when one or more steps of the work assignment are complete. Further, the indication provided by the field crew 46, 62, and 64 may be sent to the dispatching server 26 to provide the dispatching server 26 with a status or progress update. As may be appreciated, in some embodiments, the work instructions may be provided to an operator audibly.

Next, at block 140, an operator entry form associated with the work assignment may be displayed on the device 48 and may be a portion of the work assignment to be completed. The operator entry form allows the field crew 46, 62, and 64 to provide data related to the work assignment. For example, the field crew 46, 62, and 64 may enter an observation 142 onto the device 48 for documenting results of a measurement or some other observed condition. Further, when the field crew enters data in the form, the data may be submitted to the dispatching server 26 to provide details and a status update relating to the work assignment being completed.

At block 144, the device 48 detects an acknowledgment that the work assignment is completed when all portions of the work assignment have been performed. As may be appreciated, the device 48 may also detect an acknowledgment that portions of the work assignment are completed during the work assignment. Further, when a field crew operator submits a form, the device 48 may detect an acknowledgment that the form was submitted. Then, at block 146, the device 48 sends a status update including an acknowledgment of completion of the work assignment, or of a portion of the work assignment, to the dispatching server 26. The dispatching server 26 updates status information relating to the work assignment (e.g., such as in a database) and, if all portions of the work assignment are complete, may send a new work assignment to the device 48. At block 148, the device 48 may receive an updated or new work assignment to be performed from the dispatching server 26. Next, at block 150, the device 48 may display the new or updated work assignment. Thereafter, the device 48 may display directions to the location of the new or updated work assignment. It should be noted that when all work assignments have been completed, the device 48 may provide an indication to the field crew that all work assignments for the shift or workday have been completed. Using such a method 120, the dispatching server 26 may efficiently coordinate work assignment distribution to the field crews 46, 62, and 64 and dynamically update the assigned work assignments as conditions change throughout the work shift or workday.

Certain technical effects of the invention include the ability of field crews to utilize a single application to perform all functions related to completing work assignments, including receiving assignments, navigating to assignments, providing status updates for assignments, and completing forms for assignments. These functions may be performed on a single device using a single application, thus eliminating the need for multiple devices and applications. The frequent communication between the handheld electronic devices 48 and the dispatching server 26 enable the server to provide as much information as needed for the field crews to be able to find the location of the work assignment, thereby increasing the likelihood that the field crew will find the work assignment location. The dispatching server 26 is able to provide updates dynamically to the devices 48 and thereby improve routing efficiency on the fly. In addition, the dispatching server 26 may be used to Further, the dispatching server 26 maintains an up to date status of work assignments and field crews by receiving status from the electronic devices 48.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method to dispatch a repair for a utility system comprising:
displaying directions to a location of a first work assignment on an electronic device, wherein the directions update as the electronic device changes location;
displaying items to complete at least a portion of the first work assignment on the electronic device, wherein the items are displayed when the electronic device location is substantially the same as the first work assignment location;
detecting, on the electronic device, at least one operator acknowledgment of completion after the portion of the first work assignment is complete or after all portions of the first work assignment are complete, or some combination thereof; and
displaying directions to a location of a second work assignment on the electronic device when the electronic device detects that all portions of the first work assignment are complete.

2. The method of claim 1, comprising receiving, at the electronic device, the first work assignment from a dispatching server.

3. The method of claim 1, comprising sending the at least one operator acknowledgment of completion from the electronic device to a dispatching server.

4. The method of claim 1, wherein the directions to the location of the first work assignment comprise a route on a map from the electronic device location to the first work assignment location.

5. The method of claim 1, wherein the directions to the location of the first work assignment being displayed update as the electronic device location moves along a route toward the first work assignment location.

6. The method of claim 1, wherein displaying items to complete at least the portion of the first work assignment comprises displaying an operator entry form associated with the first work assignment on the electronic device to allow an operator to provide data related to the first work assignment, wherein the form is configured to be filled out on the electronic device and submitted by the electronic device to a dispatching server.

7. The method of claim 1, comprising sending a status update to a dispatching server when the electronic device location is substantially the same as the first work assignment location, the portion of the first work assignment is complete, all portions of the first work assignment are complete, or any combination thereof

8. The method of claim 1, comprising receiving, at the electronic device, a plurality of work assignments from a dispatching server as a group before a work shift starts, one after each work assignment is complete, or some combination thereof

9. The method of claim 8, comprising receiving, at the electronic device, a revised plurality of work assignments from the dispatching server based on a schedule determined by the dispatching server.

10. A system to dispatch a repair for a utility system comprising:
a dispatching server configured to:
receive work assignments to complete work orders within the utility system;
assign the work assignments to field crews;
provide the work assignments to the field crews;
receive statuses of the work assignments from the field crews at any of a plurality of stages of completion;
receive acknowledgments from the field crews when the work assignments are complete;
reassign work assignments at any time of day based at least in part on the statuses and on the acknowledgments from the field crews; and
provide reassigned work assignments to the field crews.

11. The system of claim 10, wherein the dispatching server is configured to assign or reassign work based at least in part on numbers of hours worked by the field crews, a time of day, distances traveled by the field crews, distances to be traveled by the field crews, nature or urgency levels of the work assignments, physical locations of outages, a number of vehicles operating in a vehicle fleet, maintenance records of a work vehicle, availability of the work vehicle, equipment installed in the work vehicle, or any combination thereof

12. The system of claim 10, wherein the dispatching server is configured to provide information to a dispatching terminal and receive updates from the dispatching terminal, the dispatching terminal is configured to be operated by a dispatcher, provide the dispatcher with a dispatching schedule, allow the dispatcher to manually alter the dispatching schedule, and allow the dispatcher to alter work assignment details and status.

13. The system of claim 10, wherein the dispatching server is configured to receive responses from the field crews indicating acceptances of the assigned and reassigned work assignments.

14. The system of claim 10, wherein the plurality of stages of completion comprise a work crew location being substantially the same as a work assignment location, a portion of a work assignment being complete, all portions of the work assignment being complete, or any combination thereof

15. The system of claim 10, comprising handheld electronic devices configured to be used by the field crews, wherein each handheld electronic device is configured to:
display directions to a location of a first work assignment, wherein the directions update as the handheld electronic device changes location;
display items to complete at least a portion of the first work assignment, wherein the items are displayed when the handheld electronic device location is substantially the same as the first work assignment location;
detect at least one operator acknowledgment of completion after the portion of the first work assignment is complete, after all portions of the first work assignment are complete, or some combination thereof; and
display directions to a location of a second work assignment when the handheld electronic device detects that all portions of the first work assignment are complete.

16. An article of manufacture for a dispatching system comprising:
one or more tangible, machine-readable media having encoded thereon processor-executable instructions, the instructions comprising:
instructions to display directions to a location of a first work assignment on an electronic device;
instructions to update the directions as the electronic device changes location;
instructions to display items to complete at least a portion of the first work assignment on the electronic device, wherein the items are displayed when the electronic device location is substantially the same as the first work assignment location;
instructions to detect, on the electronic device, at least one operator acknowledgment of completion after the portion of the first work assignment is complete or after all portions of the first work assignment are complete, or some combination thereof;
instructions to send the at least one operator acknowledgment of completion to a dispatching server, wherein the at least one operator acknowledgment of completion indicates a status of the first work assignment; and
instructions to display directions to a location of a second work assignment on the electronic device when the electronic device detects that all portions of the first work assignment are complete.

17. The article of manufacture of claim 16, wherein the instructions comprise instructions to receive the first work assignment from the dispatching server.

18. The article of manufacture of claim 16, wherein the instructions to display items to complete at least the portion of the first work assignment comprise instructions to display an operator entry form associated with the first work assignment on the electronic device to allow an operator to provide data related to the first work assignment, wherein the form is configured to be filled out on the electronic device and submitted by the electronic device to the dispatching server.

19. The article of manufacture of claim 16, wherein the instructions to update the directions as the electronic device changes location comprises instructions to update a route on a map as the electronic device changes location.

20. The article of manufacture of claim 16, wherein the instructions to update the directions as the electronic device changes location comprises instructions to update directions as the electronic device location moves along a route toward the first work assignment location.
